(19) United States
(12) Patent Application Publication
(10) Pub. No.: US 2019/0286381 A1
(43) Pub. Date: Sep. 19, 2019

(54) INFORMATION PROCESSING APPARATUS, INFORMATION PROCESSING METHOD, AND INFORMATION STORAGE MEDIUM

(71) Applicants: KABUSHIKI KAISHA TOSHIBA, Tokyo (JP); TOSHIBA TEC KABUSHIKI KAISHA, Tokyo (JP)

(72) Inventor: Makoto HIBINO, Kannami Tagata Shizuoka (JP)

(73) Assignees: KABUSHIKI KAISHA TOSHIBA, Tokyo (JP); TOSHIBA TEC KABUSHIKI KAISHA, Tokyo (JP)

(21) Appl. No.: 15/920,029

(22) Filed: Mar. 13, 2018

(51) Int. Cl. G06F 3/12

(52) U.S. Cl. CPC G06F 3/1205; G06F 3/1286; G06F 3/1253

(57) ABSTRACT

An information processing apparatus includes a storage unit and a processor. The storage unit stores one or more pieces of document data related to a first target and one or more pieces of document data related to a second target. The processor calculates a similarity between each of the one or more pieces of the document data related to the first target and each of the one or more pieces of the document data related to the second target, respectively, and determines a relevance between the first target and the second target, on the basis of the similarity.

### FIELD

Embodiments described herein relate generally to an information processing apparatus, an information processing method, and an information storage medium.

### BACKGROUND

In the related art, there is a case in which projects (tasks) of the same content progress in duplicate in a company. When any project progresses in duplicate in different parts of a company, it is difficult fora pair of parts to grasp such a situation. Progressing the project in duplicate is inefficient in the company, and thus it is not preferable. When each part in the company transmits information on its own project, or collects information on a project of another part, each part may look for overlapping projects.

However, when looking for the overlapping projects, a number of operations are required as described above. When the scale of the company increases, such a tendency becomes high. In addition, when determination references of need or needlessness of the overlapping projects are different from each other in each part, the overlapping projects may be overlooked.

### DESCRIPTION OF THE DRAWINGS

FIG. 1 is a schematic diagram illustrating a configuration of a system including an information processing apparatus according to some embodiments.

FIG. 2 is a block diagram illustrating an example of a configuration of an image forming apparatus according to some embodiments.

FIG. 3 is a block diagram illustrating an example of a configuration of an information processing apparatus according to some embodiments.

FIG. 4 is a flowchart illustrating an example of a collection operation of data by the image forming apparatus according to some embodiments.

FIG. 5 is a diagram illustrating an example of data stored in the image forming apparatus according to some embodiments.

FIG. 6 is a flowchart illustrating an example of another collection operation of data by the image forming apparatus according to some embodiments.

FIG. 7 is a flowchart illustrating an example of a collection operation of data by the information processing apparatus according to some embodiments.

FIG. 8 is a flowchart illustrating an example of a determination operation of a relevance between targets by the information processing apparatus according to some embodiments.

FIG. 9 is a diagram illustrating an example of a list of a count value between users, which is stored in the information processing apparatus according to some embodiments.

FIG. 10 is a diagram illustrating an example of a list of a count value between projects, which is stored in the information processing apparatus according to some embodiments.

### DETAILED DESCRIPTION

According to some embodiments, an information processing apparatus includes a storage unit and a processor. The storage unit stores one or more pieces of document data related to a first target and one or more pieces of document data related to a second target. The processor calculates a similarity between each of the one or more pieces of the document data related to the first target and each of the one or more pieces of the document data related to the second target, and determines a relevance between the first target and the second target, on the basis of the similarity.

Hereinafter, embodiments are described with reference to drawings.

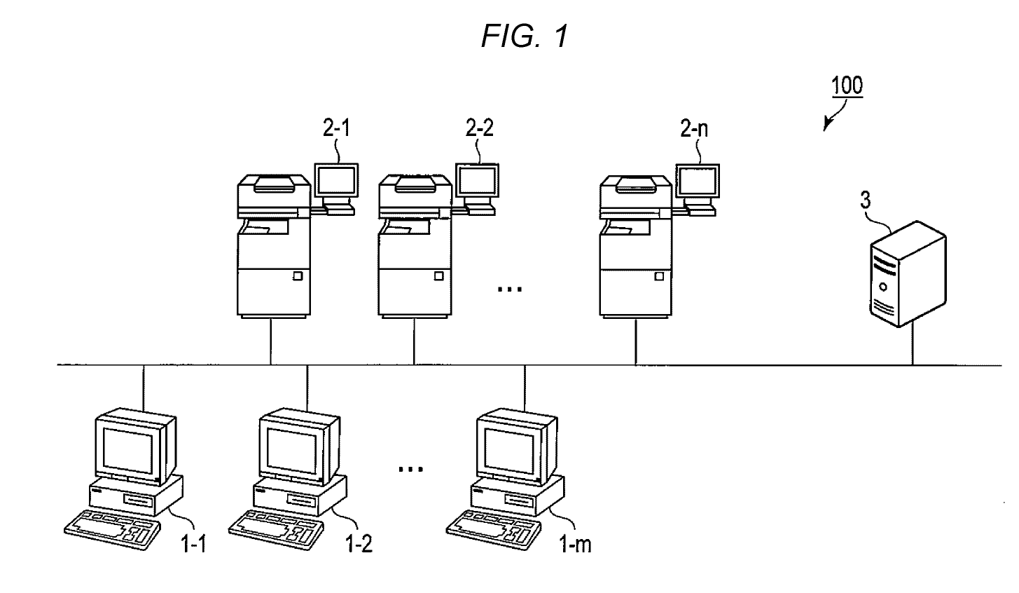

FIG. 1 is a schematic diagram illustrating a configuration of a system including an information processing apparatus.

The system 100 includes m terminals 1-1 to 1-m, n image forming apparatuses 2-1 to 2-n, and the information processing apparatus 3. The m terminals 1-1 to 1-m, the n image forming apparatuses 2-1 to 2-n, and the information processing apparatus 3 are connected to a network, and may perform communication one another. The number of the terminals is not limited. The number of the image forming apparatuses is not limited.

For example, the terminal 1-1 is a Personal Computer (PC). The terminals 1-2 to 1-m are configured identically to the terminal 1-1. The terminal 1-1 is described as an example. For example, the terminal 1-1 outputs print data to the image forming apparatus 2-1.

The print data includes document data and target information. The document data is data created by document creation software.

The target information is information indicating a target related to the document data. For example, the target is a user and a group including the user. For example, the user is an owner of the document data or a person who creates the document data. For example, the group is a project unit or a part unit, but is not limited thereto. For example, the target information includes at least one of information indicating the user or information indicating the group. For example, the information indicating the user is a user name, an ID allocated to the user, or the like. For example, the information indicating the group is a group name, a group ID, or the like. For example, the group name is a project name, a part name, or the like. For example, the group ID is an ID allocated to the project, an ID allocated to the part, or the like.

The terminal 1-1 may acquire the target information which is previously stored on the basis of a log-in of the user, and may include the target information in the print data. Alternatively, the terminal 1-1 may enable the user to obtain an input of the target information, on the basis of an input of a print instruction by the user.

For example, the image forming apparatus 2-1 is a Multi-function Peripheral (MFP). The image forming apparatuses 2-2 to 2-n are configured identically to the image forming apparatus 2-1. The image forming apparatus 2-1 is described as an example. For example, the image forming apparatus 2-1 performs a process described below.

The image forming apparatus 2-1 performs a print processing for forming an image on a print medium, on the basis of the print data from the terminal 1-1. The image forming apparatus 2-1 relates the document data and the target information included in the print data to each other, and stores the document data and the target information, while performing the print processing.

The image forming apparatus 2-1 captures image data from a manuscript, on the basis of an input of a scan processing start by the user, and stores the image data. In addition, the image forming apparatus 2-1 performs a character recognition processing on the image data, and extracts the document data. The image forming apparatus 2-1 acquires the previously stored target information, on the basis of an authentication of a use time of the image forming apparatus 2-1 by the user. Alternatively, the image forming apparatus 2-1 may enable the user to obtain an input of the target information, at the time in which the image forming apparatus 2-1 is used by the user. The image forming apparatus 2-1 relates the document data to the target information and stores the document data and the target information.

The image forming apparatus 2-1 captures image data from a manuscript, on the basis of an input of a copy processing start, and performs a copy processing for forming an image on the print medium on the basis of the image data. The image forming apparatus 2-1 performs a character recognition processing on the image data, and extracts the document data, while performing the copy processing. The image forming apparatus 2-1 acquires the previously stored target information, on the basis of an authentication of a use time of the image forming apparatus 2-1 by the user. Alternatively, the image forming apparatus 2-1 may enable the user to obtain an input of the target information, at the time in which the image forming apparatus 2-1 is used by the user. The image forming apparatus 2-1 relates the document data to the target information and stores the document data and the target information.

For example, the information processing apparatus 3 is a server. As described later, the information processing apparatus 3 determines a relevance between the two different targets, on the basis of a similarity of document data related to two different targets. A configuration of the information processing apparatus 3 is described later.

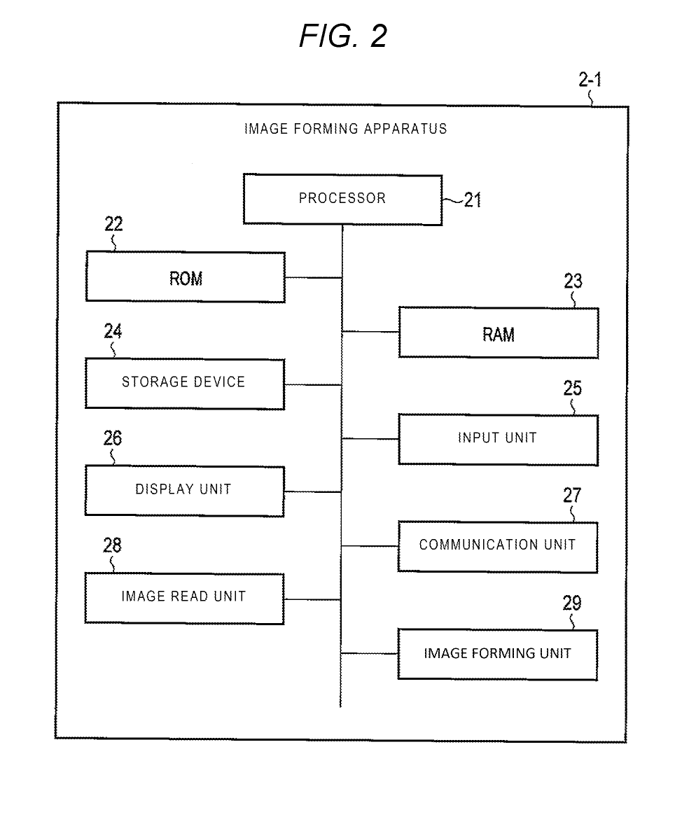

FIG. 2 is a block diagram illustrating an example of a configuration of the image forming apparatus 2-1. The image forming apparatus 2-1 includes a processor 21, a Read Only Memory (ROM) 22, a Random Access Memory (RAM) 23, a storage device 24, an input unit 25, a display unit 26, a communication unit 27, an image read unit 28, and an image forming unit 29.

For example, the processor 21 is a Central Processing Unit (CPU). The processor 21 performs various types of processes by executing a program stored in the ROM 22 or the storage device 24.

The ROM 22 stores a program, control data, or the like which enables the processor 21 to perform the various types of processes. The ROM 22 is an example of a storage unit. The RAM 23 is a working memory.

The storage device 24 is a rewritable non-volatile memory. For example, the storage device 24 is configured with a Solid State Driver (SSD), a Hard Disk Drive (HDD), or the like. The storage device 24 stores a program, control data, or the like which enables the processor 21 to perform the various types of processes. In addition, the storage device 24 stores data or the like collected by the various types of processes of the processor 21. The storage device 24 is an example of a storage unit.

The input unit 25 is an input device that receives an operation of the user. For example, the input unit 25 is a keyboard or a touch pad laminated on the display unit 26 which is described later.

The display unit 26 is an element displaying various types of information. For example, the display unit 26 is a liquid crystal display.

The communication unit 27 is an interface which enables the image forming apparatus 2-1 to communicate with other devices through a network. The communication unit 27 may be a wired communication interface or a wireless communication interface.

The image read unit 28 is a scanner which reads a manuscript, and captures the image data from the manuscript. For example, the image read unit 28 includes an image sensor or the like. The image sensor is an imaging element in which pixels converting light into an electrical signal (image signal) are arranged in a line shape. For example, the image sensor is configured with a Charge Coupled Device (CCD), a Complementary Metal Oxide Semiconductor (CMOS), or other image elements.

The image forming unit 29 may be a printer that forms an image on the print medium. For example, the image forming unit 29 may include an exposure drum, an electric charge charger, an exposer, a developer, and the like. A surface of the exposure drum is uniformly charged with electricity by the electric charge charger. The exposer emits light having a wavelength that may form a latent image on the exposure drum that is charged with electricity, according to an electrical signal of the document data or the image data, and forms a static electricity latent image on the exposure drum that is charged with electricity. The developer attaches a toner (developer) on the static electricity latent image that is formed on the exposure drum, and forms an image of the toner (toner image) on the surface of the exposure drum. The image forming unit 29 transfers the toner image that is formed on the surface of the exposure drum to the print medium and fixates the toner image to the print medium, so as to form an image on the print medium.

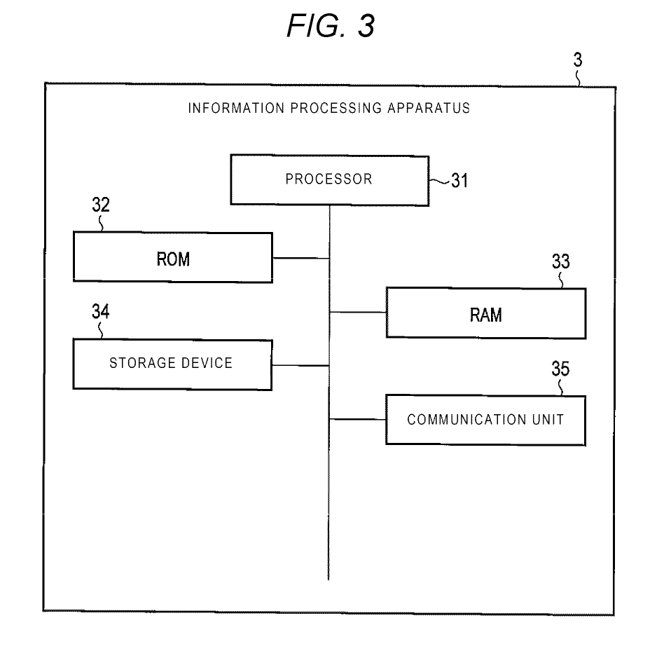

FIG. 3 is a block diagram illustrating an example of a configuration of the information processing apparatus 3. The information processing apparatus 3 includes a processor 31, a ROM 32, a RAM 33, a storage device 34, and a communication unit 35.

For example, the processor 31 maybe a CPU. The processor 31 performs various types of processes by executing a program stored in the ROM 32 or the storage device 34.

The ROM 32 stores a program, control data, or the like which enables the processor 31 to perform the various types of processes. The ROM 32 is an example of a storage unit. The RAM 33 is a working memory.

The storage device 34 is a rewritable non-volatile memory. For example, the storage device 34 is configured with an SSD, an HDD, or the like. The storage device 34 stores a program, control data, or the like which enables the processor 31 to perform the various types of processes. In addition, the storage device 34 stores data or the like collected by the various types of processes of the processor 31. The storage device 34 is an example of a storage unit.

Next, an operation of the image forming apparatus 2-1 is described.

Here, a collection operation of data by the image forming apparatus 2-1 is described.

First, a print processing time is described.

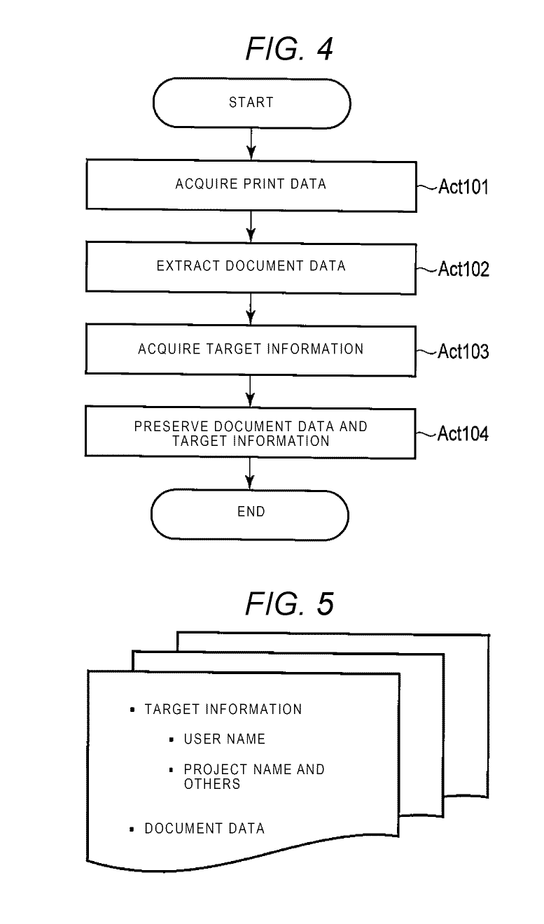

FIG. 4 is a flowchart illustrating an example of the collection operation of the data by the image forming apparatus 2-1 at the print processing time.

The processor 21 acquires print data (Act101). In Act101, the processor 21 acquires, through the communication unit 27, the print data that is transmitted from the terminal 1-1 to the image forming apparatus 2-1 through a network.

The processor 21 extracts the print data (Act102). In Act102, the processor 21 extracts the document data included in the print data.

The processor 21 acquires the target information (Act103). In Act103, the processor 21 acquires the target information included in the print data.

The processor 21 preserves the document data and the target information (Act104). In Act104, the processor 21 relates the document data to the target information and preserves the document data and the target information in the storage device 24.

FIG. 5 is a diagram illustrating an example of the document data and the target information stored in the storage device 24. The storage device 24 relates the document data to the target information and stores the document data and the target information, for each of pieces of the document data. For example, the target information includes a user name, a project name, and the like related to the document data. In addition, the storage device 24 may maintain a state in which the document data is related to the target information, for each of pieces of the document data. For example, the storage device 24 may realize maintaining the document data and the target information, by a form of a database, a file, a list, or the like. The form of the maintenance of the data by the storage device 24 is not limited thereto.

Next, a scan processing time and a copy processing time are described.

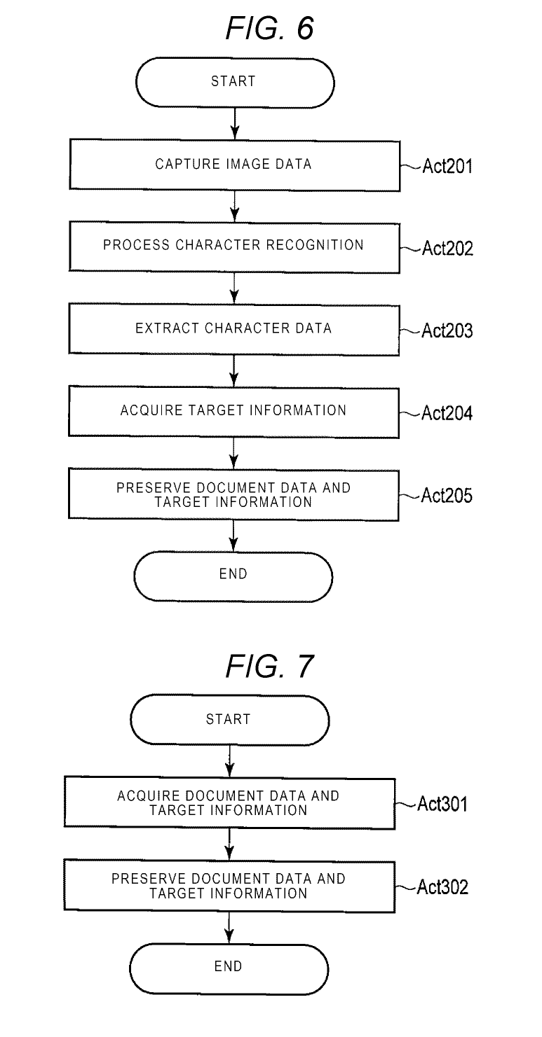

FIG. 6 is a flowchart illustrating an example of the collection operation of the data by the image forming apparatus 2-1 in the scan processing time and the copy processing time.

The processor 21 captures the image data (Act201). In Act201, the processor 21 controls the image read unit 28 so that the image read unit 28 captures the image data from the manuscript, on the basis of the input of the scan processing start by the user. Similarly, the processor 21 controls the image read unit 28 so that the image read unit 28 captures the image data from the manuscript, on the basis of the input of the copy processing start by the user.

The processor 21 performs the character recognition processing on the image data (Act202). In Act202, the processor 21 performs the character recognition processing such as an Optical Character Recognition (OCR) processing on the image data.

The processor 21 extracts the document data (Act203). In Act203, the processor 21 extracts the document data from the image data on which the character recognition processing is performed.

The processor 21 acquires the target information (Act204). In Act204, the processor 21 acquires the target information that is previously stored in the storage device 24, on the basis of, for example, the authentication of the use time of the image forming apparatus 2-1 by the user. Alternatively, the processor 21 may acquire the target information, on the basis of, for example, the target information that is input to the input unit 25 by the user at the time in which the image forming apparatus 2-1 is used.

The processor 21 preserves the document data and the target information (Act205). In Act205, the processor 21 relates the document data to the target information and stores the document data and the target information in the storage device 24. Therefore, the storage device 24 relates the document data to the target information and stores the document data and the target information, for each of pieces of the document data, as described by using FIG. 5.

Next, an operation of the information processing apparatus 3 is described.

First, a collection operation of data by the information processing apparatus 3 is described.

FIG. 7 is a flowchart illustrating an example of the collection operation of the data by the information processing apparatus 3.

The processor 31 acquires the document data and the target information (Act301). In Act301, the processor 31 acquires, through the communication unit 35, the document data and the target information that are transmitted from the image forming apparatus 2-1 to the information processing apparatus 3 through a network.

The processor 31 preserves the document data and the target information (Act302). In Act302, the processor 31 relates the document data to the target information and preserves the document data and the target information in the storage device 34. That is, the storage device 34 stores one or more pieces of document data related to a first target and one or more pieces of document data related to a second target.

In addition, as described above, the processor 31 acquires the document data and the target information from the image forming apparatus 2-1, but is not limited thereto. The processor 31 may acquire the document data and the target information from each of the image forming apparatuses 2-1 to 2-n included in the system 100. The storage device 34 stores the document data and the target information by relating the document data to the target information, for each of pieces of the document data.

Next, a determination operation of a relevance between targets by the information processing apparatus 3 is described.

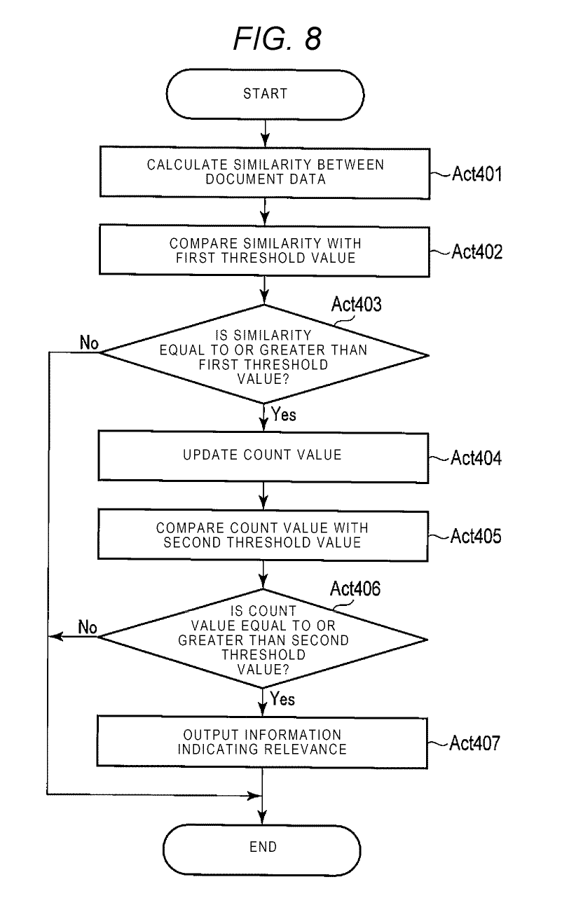

FIG. 8 is a flowchart illustrating an example of the determination operation of the relevance between the targets by the information processing apparatus 3. Whenever the processor 31 acquires the document data, the processor 31 performs the determination operation of the relevance between the targets, by comparing the acquired document data with the entire document data stored in the storage device 34. Here, for simplification of description, the one or more pieces of the document data related to the first target and one or more pieces of the document data related to the second target are described as an example.

The processor 31 calculates a similarity between two pieces of the document data (Act401). In Act401, the processor 31 calculates a similarity between each of the one or more pieces of the document data related to the first target and each of the one or more pieces of the document data related to the second target. That is, the processor 31 combines one piece of the document data related to the first target with one piece of the document data related to the second target as one combination, and calculates a similarity between the two pieces of the document data. With respect to the entire combination of the one or more pieces of the document data related to the first target and the one or more pieces of the document data related to the second target, the processor 31 calculate a similarity between the two pieces of the document data for each combination. For example, the processor 31 may calculate the similarity, by Cos similarity, Doc2Vec, or the like. The processor 31 may calculate the similarity by other methods. In addition, the processor 31 may compare the two pieces of the document data with each other between two different targets, with reference to the target information, or may omit the comparison between the two pieces of the document data related to the same target. In addition, the processor 31 may calculate a similarity between two pieces of the document data for each combination, with respect to a random plurality of combinations of the document data related to the first target and the document data related to the second target.

A specific example of Act401 is described. For example, it is assumed that there are document data 1A and document data 1B related to the first target. For example, it is assumed that there are document data 2A and document data 2B related to the second target. The processor 31 compares the document data 1A with the document data 2A, and calculates a similarity between the document data 1A and the document data 2A. The processor 31 compares the document data 1A with the document data 2B, and calculates a similarity between the document data 1A and the document data 2B. The processor 31 compares the document data 1B with the document data 2A, and calculates a similarity between the document data 1B and the document data 2A. The processor 31 compares the document data 1B with the document data 2B, and calculates a similarity between the document data 1B and the document data 2B. The processor 31 may omit comparing the document data 1A with the document data 1B, and comparing the document data 2A with the document data 2B.

The processor 31 compares the similarity with a first threshold value (Act402). In Act402, the processor 31 compares the similarity with the first threshold value, whenever the similarity between the document data related to the first target and the document data related to the second target is calculated. When the similarity is equal to or greater than the first threshold value, the processor 31 may determine that the similarity between the two pieces of the document data is high. When the similarity is not equal to or greater than the first threshold value, the processor 31 may determine that the similarity between the two pieces of the document data is low. The way the first threshold value is set is not limited. For example, the processor 31 may calculate the similarity between the two pieces of the document data in a range of zero to 1, by Cos similarity. The larger the value of the similarity is, the higher the similarity of the two pieces of the document data is. For example, the first threshold value is 0.7 or the like, but is not limited thereto.

A specific example of Act402 is described. For example, the processor 31 compares the similarity between the document data 1A and the document data 2A with the first threshold value. The processor 31 compares the similarity between the document data 1A and the document data 2B with the first threshold value. The processor 31 compares the similarity between the document data 1B and the document data 2A with the first threshold value. The processor 31 compares the similarity between the document data 1A and the document data 1B with the first threshold value.

The processor 31 determines whether there is a combination of the document data of which the similarity is equal to or greater than the first threshold value (Act403). In Act403, the processor 31 determines whether there is the combination of the document data of which the similarity is equal to or greater than the first threshold value, between the first target and the second target. When there is no combination of the document data of which the similarity is equal to or greater than the first threshold value (Act403, No), the processor 31 ends the processing. When there is the combination of the document data of which the similarity is equal to or greater than the first threshold value (Act403, Yes), the processor 31 updates a count value (Act404). In Act404, the processor 31 updates the count value, according to the number of the combinations of the document data between the first target and the second target, in which the similarity is equal to or greater than the first threshold value. The count value indicates the relevance between two targets. For example, the processor 31 adds one to the count value, for each of the combinations of the document data between the first target and the second target, in which the similarity is equal to or greater than the first threshold value. The count value corresponds to the number of combinations of the document data similar to each other in two different targets. As described above, the processor 31 may update the count value indicating the relevance between the two different targets, for each of combinations of the two different targets, with reference to the target information.

A specific example of Act404 is described. For example, when the similarity between the document data 1A and the document data 2A is equal to or greater than the first threshold value, the processor 31 adds one to the count value indicating the relevance between the first target and the second target. When the similarity between the document data 1A and the document data 2B is equal to or greater than the first threshold value, the processor 31 adds one to the count value indicating the relevance between the first target and the second target.

In addition, in Act404, the processor 31 preserves the count values of each of the combinations of the two different targets in the storage device 34. For example, the processor 31 preserves count values of each of combinations of users of two different people in the storage device 34. As another example, the processor 31 stores count values of each of combinations of two different groups in the storage device 34. For example the storage device 34 stores the count values in a list form. The list form of the count values stored in the storage device 34 is described later.

The processor 31 compares the count value with a second threshold value (Act405). In Act405, the processor 31 compares the count value indicating the relevance between the first target and the second target with the second threshold value. When the count value is equal to or greater than the second threshold value, the processor 31 determines that the relevance between the two different targets is high. When the relevance between the two different targets is high, it may be assumed that the two different targets perform similar projects. On the other hand, when the count value is not equal to or greater than the second threshold value, the processor 31 determines that the relevance between the two different targets is low. When the relevance between the two different targets is low, it maybe assumed that the two different targets do not perform similar projects. The way the second threshold value is set is not limited. As described above, the processor 31 may compare the count value with the second threshold value for each of the combinations of the two different targets.

The processor determines whether or not the count value is equal to or greater than the second threshold value (Act406). In Act 406, the processor 31 determines whether or not the count value indicating the relevance between the first target and the second target is equal to or greater than the second threshold value. When the count value is not equal to or greater than the second threshold value (Act406, No), the processor 31 ends the processing. When the count value is equal to or greater than the second threshold value (Act406, Yes), the processor 31 outputs information indicating the relevance between the two targets (Act407). In Act407, when the number of combinations of the document data of which the similarity is equal to or greater than the first threshold value is equal to or greater than the second threshold value, the processor 31 outputs the information indicating the relevance between the first target and the second target. As described above, the processor 31 outputs the information indicating the relevance between the two targets corresponding to the count value. The information indicating the relevance between the two targets may indicate that the two targets handle similar document data. The information indicating the relevance between the two targets is not required to include information specifying contents of the similar document data. Therefore, security of the document data is maintained.

In Act407, an aspect of outputting the information by the processor 31 is not particularly limited, but processor 31 may output the information as described later. For example, the processor 31 may output the information indicating the relevance between the two targets by including the information indicating the relevance between the two targets in an email. The processor 31 outputs the information to a previously registered notification place by including the information in the email. When the target is a user, the notification place of the email may include two users corresponding to the count value that is equal to or greater than the second threshold value. The notification place of the email may include superiors of each of the two users. On the other hand, when the target is a group, the notification place of the email may include a user included in two groups corresponding to the count value that is equal to or greater than the second threshold value. The notification place of the email may include a manager who manages each of the two groups. The receiver of the email may grasp that the similar document data are handled, that is, similar works are performed, by the two different targets. As another example, the processor 31 may output the information indicating the relevance between the two targets by including an instruction for printing by any of the image forming apparatuses 2-1 to 2-n in the information. A person who checks a printed matter may grasp that the similar document data are handled, that is, the similar works are performed, by the two different targets.

According to the processes of the above described Acts 402 to 406, the processor 31 may determine the relevance between the first target and the second target on the basis of the similarity. A case in which a target is a user is described. The first target is a first user, and the second target is a second user. The processor 31 determines a relevance between the first user and the second user, on the basis of similarities of all of (a plurality of) combinations of document data of the first user and document data of the second user. The case where the target is a group is described. The first target is a first group including one or more users, and the second target is a second group including one or more users. The processor 31 determines a relevance between the first group and the second group, on the basis of similarities of all of (a plurality of) combinations of document data of the first group and document data of the second group. In addition, the processes of the above described Acts 402 to 406 are examples. The determining process based on the similarity by the processor 31 is not limited thereto.

According to the processes of the above described Acts 405 to 406, the processor 31 determines the relevance between the first target and the second target on the basis of the number of the combinations of the document data of which the similarity is equal to or greater than the first threshold value. The above described Acts 405 to 406 are examples. The determining process based on the number of the combinations of the document data by the processor 31 is not limited thereto.

Next, the list of the count value between the targets, which is stored in the storage device 34 is described.

The list of the count value between the users is described.

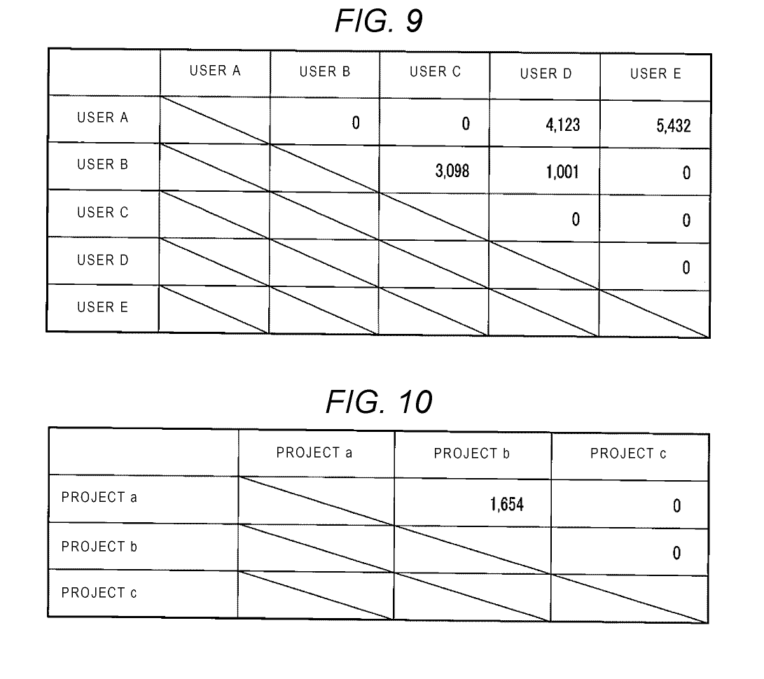

FIG. 9 is a diagram illustrating an example of the list of the count value between the users, which is stored in the storage device 34.

The list of FIG. 9 manages count values among mutual users of a user A, a user B, a user C, a user D, and a user E. The processor 31 may determine a relevance between the users, by comparing each of the count values managed by the list of FIG. 9 with the second threshold value.

A list of a count value between groups is described. Here, a project is described as an example.

FIG. 10 is a diagram illustrating an example of the list of the count value between the projects, which is stored in the storage device 34. The list of FIG. 10 manages count values among mutual projects of a project a, a project b, and a project c. In addition, each of the projects may include or may not include a user overlapping a user who belongs to another project. For example, the project a includes the user A and the user B, and the project b includes the user C and the user D. As another example, the project a includes the user A and the user B, and the project b includes the user A and the user D. The processor 31 may determine a relevance between the projects, by comparing each of the count values managed by the list of FIG. 10 with the second threshold value.

According to some embodiments, the information processing apparatus 3 determines the relevance between the first target and the second target, on the basis of the similarity between the document data of the first target and the document data of the second target. Therefore, the information processing apparatus 3 may determine that the first target and the second target print, copy and scan documents of which a similarity is high several times. The information processing apparatus 3 may appropriately determine the relevance between the first target and the second target, by referring to similarities of a plurality of combinations of the document data of the first target and the document data of the second target. For example, even though the first target and the second target have the same standardized document, the information processing apparatus 3 does not determine the relevance between the first target and the second target from only document data of the document. Therefore, the information processing apparatus 3 may appropriately determine the relevance between the first target and the second target.

In addition, the information processing apparatus 3 determines the relevance between the first target and the second target, on the basis of the number of the combinations of the document data of which the similarity is equal to or greater than the first threshold value. Therefore, the information processing apparatus 3 may determine that the first target and the second target print, copy and scan documents of which a similarity is high several times.

In addition, when the count value is equal to or greater than the second threshold value, the information processing apparatus 3 outputs the information indicating the relevance between the first target and the second target. Therefore, the information processing apparatus 3 may appropriately determine the degree of the similarity between the first target and the second target, by comparing the count value with the second threshold value. In addition, a person who checks the information may grasp that the similar document data are handled by the first target and the second target, that is, the similar works are performed by the first target and the second target.

In addition, the information processing apparatus 3 determines a relevance between different users, on the basis of similarities of all of (a plurality of) combinations of the document data between the different users. Therefore, the information processing apparatus 3 may appropriately determine the relevance between the different users.

In addition, the information processing apparatus 3 determines a relevance between different groups, on the basis of similarities of all of (a plurality of) combinations of the document data between the different groups. Therefore, the information processing apparatus 3 may appropriately determine the relevance between the different groups. For example, it is highly possible that a plurality of users included in the same group handle similar document data. Therefore, information indicating a relevance between the users included in the same group is not useful . The information processing apparatus 3 may obtain useful information, by determining the relevance between the different groups.

In addition, the operation of determining the relevance between the targets, which is described in the above embodiment, may be performed by the image forming apparatus 2-1 such as an MFP. In this case, the processor 21 of the image forming apparatus 2-1 performs the same process as that of the processor of the information processing apparatus 3, which is described above.

In addition, a program enabling a processor to perform the various types of processes which are described above may be installed from an information storage medium that stores the program to a device. For example, the information storage medium is a CD-ROM or the like. The information storage medium may be a device-readable storage medium, but is not limited thereto.

While certain embodiments have been described, these embodiments have been presented by way of example only, and are not intended to limit the scope of invention. Indeed, the novel apparatus and methods described herein may be embodied in a variety of other forms; furthermore, various omissions, substitutions and changes in the form of the apparatus and methods described herein may be made without departing from the spirit of the inventions. The accompanying claims and their equivalents are intended to cover such forms or modifications as would fall within the scope and spirit of the inventions.

What is claimed is:

1. An information processing apparatus comprising:
a storage memory configured to store one or more pieces of document data related to a first target and one or more pieces of document data related to a second target; and
a processor configured to calculate a similarity between each of the one or more pieces of the document data related to the first target and each of the one or more pieces of the document data related to the second target, and to determine a relevance between the first target and the second target, on the basis of the similarity.

2. The apparatus according to claim 1,
wherein the processor is configured to determine the relevance between the first target and the second target, on a basis of a number of combinations of the document data of which the similarity is equal to or greater than a first threshold value.

3. The apparatus according to claim 2,
wherein, when the number of the combinations is equal to or greater than a second threshold value, the processor is configured to output information indicating the relevance between the first target and the second target.

4. The apparatus according to claim 3, wherein the information indicating the relevance includes the number of the combinations.

5. The apparatus according to claim 1,
wherein the first target is a first user,
the second target is a second user, and
the processor is configured to determine a relevance between the first user and the second user, on the basis of the similarity.

6. The apparatus according to claim 1,
wherein the first target is a first group including one or more users,
the second target is a second group including one or more users, and
the processor is configured to determine a relevance between the first group and the second group, on the basis of the similarity.

7. A system comprising:
one or more image forming apparatuses configured to create document data; and
an image processing apparatus arranged to receive document data from the plurality of image forming apparatuses, wherein the image processing apparatus comprises:
a storage memory configured to store one or more pieces of document data related to a first target and one or more pieces of document data related to a second target; and
a processor configured to calculate a similarity between each of the one or more pieces of the document data related to the first target and each of the one or more pieces of the document data related to the second target, and to determine a relevance between the first target and the second target, on the basis of the similarity.

8. The system of claim 7, further comprising:
one or more terminals configured to provide document data to the image processing apparatus.

9. The system according to claim 7,
wherein the processor is configured to determine the relevance between the first target and the second target, on a basis of a number of combinations of the document data of which the similarity is equal to or greater than a first threshold value.

10. The system according to claim 9,
wherein, when the number of the combinations is equal to or greater than a second threshold value, the processor is configured to output information indicating the relevance between the first target and the second target.

11. The system according to claim 7,
wherein the first target is a first user,
the second target is a second user, and
the processor is configured to determine a relevance between the first user and the second user, on the basis of the similarity.

12. The system according to claim 7,
wherein the first target is a first group including one or more users,
the second target is a second group including one or more users, and
the processor is configured to determine a relevance between the first group and the second group, on the basis of the similarity.

13. An information processing method comprising:
calculating a similarity between each of one or more pieces of document data related to a first target and each of one or more pieces of document data related to a second target; and
determining a relevance between the first target and the second target, on the basis of the similarity.

14. The method according to claim 13,
wherein the relevance is determined between the first target and the second target on a basis of a number of combinations of the document data of which the similarity is equal to or greater than a first threshold value.

15. The method according to claim 14,
wherein, when the number of the combinations is equal to or greater than a second threshold value, outputting information indicating the relevance between the first target and the second target.

16. The method according to claim 13,
wherein the first target is a first user,
the second target is a second user, and
the relevance between the first user and the second user is determined on the basis of the similarity.

17. A non-transitory information storage medium that stores a program causing a processor to execute a process of:
calculating a similarity between each of one or more pieces of document data related to a first target and each of one or more pieces of document data related to a second target; and
determining a relevance between the first target and the second target on the basis of the similarity.

18. The non-transitory information storage medium according to claim 17,
wherein in the process the relevance is determined between the first target and the second target on a basis of a number of combinations of the document data of which the similarity is equal to or greater than a first threshold value.

19. The non-transitory information storage medium according to claim 17,
wherein in the process, when the number of the combinations is equal to or greater than a second threshold value, outputting information indicating the relevance between the first target and the second target.

20. The non-transitory information storage medium according to claim 17,
wherein the first target is a first user,
the second target is a second user, and
in the process the relevance between the first user and the second user is determined on the basis of the similarity.
